(19) United States
(12) Patent Application Publication
(10) Pub. No.: US 2008/0119224 A1
(43) Pub. Date: May 22, 2008

(54) MOBILE TERMINAL FOR PROVIDING CAMERA ROAMING SERVICE AND METHOD THEREOF

(75) Inventor: Jung-Su HA, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/833,743

(22) Filed: Aug. 3, 2007

(30) Foreign Application Priority Data
Nov. 17, 2006 (KR) 2006-113770

(51) Int. Cl. H04M 1/00

(52) U.S. Cl. 455/556.1

(57) ABSTRACT

A camera roaming service method of a mobile terminal is provided. The method includes the steps of, if camera roaming of a roaming country in which the mobile terminal is currently located is requested by a user during a roaming service, determining whether a power source frequency of the roaming country is equal to a power source frequency of the mobile terminal, and if the two power source frequencies are not the same, adjusting a camera clock frequency according to the power source frequency of the roaming country. Accordingly, when an international roaming service is performed, a camera clock frequency can be adjusted according to a power source frequency of a roaming country. In addition, since optimal image quality of a camera can be obtained everywhere a roaming service is performed (in particular, indoors), a user can capture a clear image.

### PRIORITY

This application claims the benefit under 35 U.S.C. §119(a) of a Korean patent application filed in the Korean Intellectual Property Office on Nov. 17, 2006 and assigned Serial No. 2006-113770, the entire disclosure of which is hereby incorporated by reference.

### BACKGROUND OF THE INVENTION

1. Field of the Invention:

The present invention relates generally to a roaming service method of a mobile terminal. More particularly, the present invention relates to a mobile terminal for providing a camera roaming service and a method thereof.

2. Description of the Related Art:

Recently, mobile terminals, which are available anywhere in the world, have been considered necessities that people must always carry.

Thus, mobile communication providers are providing a roaming service so that mobile terminal subscribers can use domestic mobile terminals overseas with the same telephone number.

The conventional roaming service only provides service for phone calls without considering a clock frequency of a camera, which is one of the major components of a mobile terminal.

Typically, a camera clock frequency of a mobile terminal equipped with a camera is set based on a power source frequency of a country in which the mobile terminal is used. For example, a clock frequency of a camera equipped in a mobile terminal used in South Korea is set based on 60 Hz, the power source frequency of South Korea, to control the quality of images captured by the camera.

However, since the power source frequency of each country in the world is not the same, when the roaming service is applied to a mobile terminal equipped with a camera, if the mobile terminal captures an image in a country which uses a power source frequency different from that of the mobile terminal, banding noise may occur. For example, if a mobile terminal of which a camera clock frequency is set based on a power source frequency of 60 Hz captures an indoor image in an area in which a power source frequency of 50 Hz is used, the captured image is frequently blurred because of the frequency mismatch.

### SUMMARY OF THE INVENTION

An aspect of the present invention is to address at least the above problems and/or disadvantages and to provide at least the advantages below. Accordingly, an aspect of the present invention is to provide a mobile terminal for adjusting a camera clock frequency according to a power source frequency of a country in which the mobile terminal is currently located when an international roaming service is performed, and a method thereof.

Another aspect of the present invention is to provide a mobile terminal for capturing an image with clear image quality in a country in which the mobile terminal is currently located when an international roaming service is performed, and a method thereof.

According to one aspect of the present invention, a camera roaming service method of a mobile terminal is provided. The method comprises, if camera roaming of a roaming country in which the mobile terminal is currently located is requested by a user during roaming service, determining whether a power source frequency of the roaming country is equal to a power source frequency of the mobile terminal, and if the two power source frequencies are not the same, adjusting a camera clock frequency according to the power source frequency of the roaming country.

According to another aspect of the present invention, a camera roaming service method of a mobile terminal is provided. The method comprises receiving a roaming authentication code and a roaming country code as a message from a roaming service provider of a country in which the mobile terminal is currently located during a roaming service, determining whether a power source frequency of a roaming country corresponding to the received roaming country code is equal to a power source frequency of the mobile terminal, and if the two power source frequencies are not the same, adjusting a camera clock frequency according to the power source frequency of the roaming country.

According to another aspect of the present invention, a mobile terminal equipped with a camera is provided. The mobile terminal comprises a memory for storing a power source frequency of each country and a camera register value for adjusting a clock frequency of the camera according to the power source frequency, and a controller for adjusting the camera clock frequency by reading a camera register value, which corresponds to a power source frequency of a roaming country in which the mobile terminal is currently located, from the memory if camera roaming of the roaming country is requested by a user during a roaming service.

According to another aspect of the present invention, a mobile terminal equipped with a camera is provided. The mobile terminal comprises a memory for storing a power source frequency of each country and a camera register value for adjusting a clock frequency of the camera according to the power source frequency, a Radio Frequency (RF) transceiver for transmitting unique information of the mobile terminal for roaming authentication in a roaming service to a roaming service provider of a country in which the mobile terminal is currently located and receiving a roaming authentication code and a roaming country code as a message from the roaming service provider, and a controller for adjusting the camera clock frequency by reading a camera register value, which corresponds to a power source frequency of a roaming country corresponding to the received roaming country code, from the memory.

### BRIEF DESCRIPTION OF THE DRAWINGS

The above and other aspects, features and advantages of the present invention will become more apparent from the following detailed description of certain exemplary embodiments when taken in conjunction with the accompanying drawings, in which:

FIG. 1 is a block diagram of a mobile terminal according to an exemplary embodiment of the present invention;

FIG. 2 is a flowchart of a camera roaming service method of a mobile terminal according to an exemplary embodiment of the present invention; and

FIGS. 3A and 3B are flowcharts of a camera roaming service method of a mobile terminal according to another exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

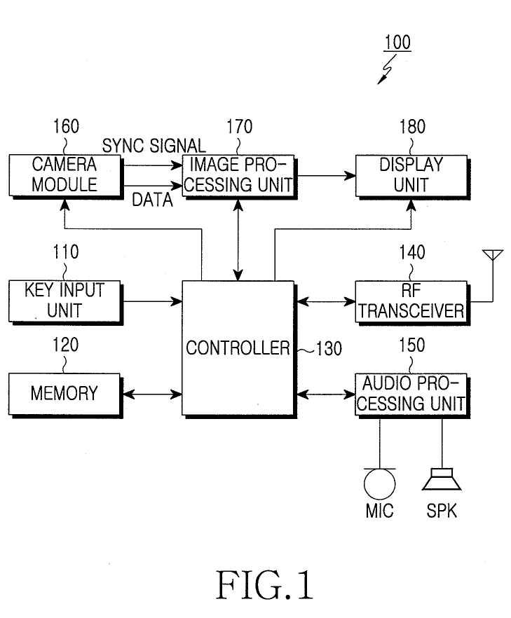

FIG. 1 is a block diagram of a mobile terminal 100 according to an exemplary embodiment of the present invention.

Referring to FIG. 1, the mobile terminal 100 includes a key input unit 110, a memory 120, a controller 130, a Radio Frequency (RF) transceiver 140, an audio processing unit 150, a camera module 160, an image processing unit 170, and a display unit 180.

The key input unit 110 has a key matrix structure with character keys, numeric keys, various function keys, and an external volume key and outputs a key input signal corresponding to a key selected by a user to the controller 130.

The memory 120 stores a power source frequency of each country and a camera register value for adjusting a clock frequency of the camera module 160 according to the power source frequency. The camera register value can be stored as, for example, 0 when the power source frequency is 50 Hz or 1 when the power source frequency is 60 Hz.

The controller 130 controls the general operation of the mobile terminal 100. The controller 130 may include a camera register for storing the clock frequency of the camera module 160, and in this case, the controller 130 generates a camera clock frequency according to a setting value of the camera register and outputs the camera clock frequency to the camera module 160.

If camera roaming of a roaming country in which the mobile terminal 100 is currently located is requested by the user during a roaming service, the controller 130 sets a camera register value by reading the camera register value, which corresponds to a power source frequency of the roaming country, from the memory 120 and adjusts the camera clock frequency according to the set value. In this case, the controller 130 may compare the power source frequency of the roaming country and a current power source frequency of the mobile terminal 100 and adjust the camera clock frequency only if the two frequencies are not the same.

When a roaming service is performed, the controller 130 may begin the roaming service by transmitting unique information (e.g., an Electronic Serial Number (ESN), which is a device serial number) of the mobile terminal 100 for roaming authentication to a roaming service provider of a roaming country and receiving a roaming authentication code and a roaming country code as a message from the roaming service provider. In this case, the controller 130 can adjust the camera clock frequency by reading and setting a camera register value, which corresponds to a power source frequency of a roaming country corresponding to the received roaming country code, from the memory 120.

If the message received from the roaming service provider contains a camera register value for adjusting the camera clock frequency according to a power source frequency of a roaming country, the controller 130 may compare the camera register value and a camera register value currently set in the mobile terminal 100, and if the two camera register values are not the same, the controller 130 may replace the camera register value of the mobile terminal 100 with the camera register value contained in the message and adjust the camera clock frequency.

The controller 130 controls the RF transceiver 140 to transmit and receive speech data, text data, image data, and control data. To do this, the RF transceiver 140 includes an RF transmitter (not shown) for upstream converting a frequency of a signal to be transmitted and amplifying the signal and an RF receiver (not shown) for low noise amplifying a received signal and downstream converting a frequency of the received signal.

Under the control of the controller 130, the RF transceiver 140 transmits the unique information (e.g., the ESN) of the mobile terminal 100 for roaming authentication in a roaming service to a roaming service provider of a country in which the user is currently located and receives a roaming authentication code and a roaming country code as a message from the roaming service provider. The message may contain a camera register value for adjusting the camera clock frequency according to a power source frequency of a roaming country.

The audio processing unit 150 modulates an electrical signal input via a microphone to speech data, and demodulates encoded speech data input from the RF transceiver 140 to an electrical signal and outputs the electrical signal to a speaker.

The audio processing unit 150 may include a codec to convert a digital audio signal input from the RF transceiver 140 to an analog audio signal or convert an analog audio signal input from the microphone to a digital audio signal. The codec may include a data codec for processing packet data and an audio codec for processing an audio signal such as speech and may be included in the controller 130.

The camera module 160 can include a lens module (not shown) that can be exposed or hidden and captures an image according to the camera clock frequency.

The camera module 160 may also include a camera sensor (not shown) for converting an optical signal obtained by capturing an image to an electrical signal and a signal processing unit (not shown) for converting an analog image signal received from the camera sensor to digital data.

The camera sensor may be a charge coupled device (CCD) sensor, and the signal processing unit can be implemented by a digital signal processor (DSP). The camera sensor and the signal processing unit can be implemented in one body or separately.

The image processing unit 170 generates screen data to display the digital data output from the camera module 160.

The image processing unit 170 processes an image signal output from the camera module 160 on a frame basis and outputs the frame image data by fitting it for the characteristics and size of the display unit 180. The image processing unit 170 includes an image codec (not shown), thereby compressing frame image data to be displayed on the display unit 180 according to a set format or decompressing compressed frame image data to original frame image data.

In addition, the image processing unit 170 may have an On Screen Display (OSD) function, and, if so, the controller 130 can control the image processing unit 170 to output OSD data based on the display screen size.

The display unit 180 can include a Liquid Crystal Display (LCD) and outputs various kinds of display data created by the mobile terminal 100. If the LCD is a touch screen device, the display unit 180 may operate as an input module.

The display unit 180 also displays an image corresponding to an image signal output from the image processing unit 170 and displays user data output from the controller 130.

In the above-described exemplary embodiment, the camera register for adjusting the camera clock frequency is included in the controller 130. If a multimedia chip for performing a multimedia function is separately included in the mobile terminal 100, however, the camera register may be included in the multimedia chip.

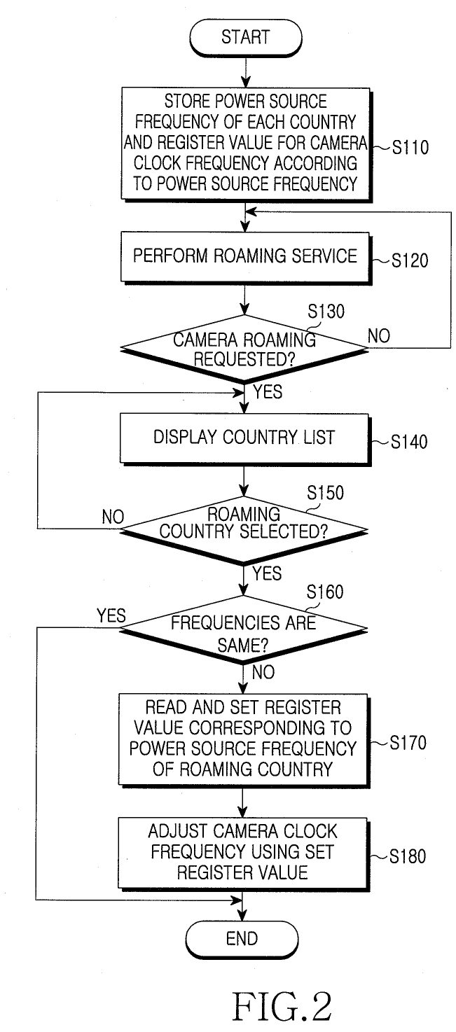

FIG. 2 is a flowchart of a camera roaming service method of a mobile terminal according to an exemplary embodiment of the present invention.

Referring to FIGS. 1 and 2, the controller 130 stores a power source frequency of each country and a camera register value for adjusting a camera clock frequency according to the power source frequency in the memory 120 in step S 10. The controller 130 may store the power source frequencies and corresponding camera register values in the memory 120 in the form illustrated in Table 1.

TABLE 1

| | Power source | Camera |
|---|---|---|
| Country | frequency (Hz) | register value |
| United States of | 60 | 1 |
| America | | |
| Great Britain | 50 | 0 |
| China | 60 | 1 |
| The Czech Republic | 50 | 0 |
| Australia | 60 | 1 |

Although Table 1 shows only power source frequencies of countries and camera register values corresponding to the power source frequencies, country codes can also be included.

The controller 130 performs a roaming service according to a user request in step S120. The controller 130 performs an authentication process of the mobile terminal 100 with a roaming service provider of a roaming country, and if roaming authentication is obtained from the roaming service provider, the controller 130 performs the roaming service. Since the authentication process of the roaming service is well known by those skilled in the art, a detailed description is omitted.

The controller 130 determines in step S130 whether camera roaming is requested by the user during the roaming service.

If it is determined in step S130 that camera roaming is requested by the user, the controller 130 generates a country list and displays the country list on the display unit 180 in step S140 so that the user can select a roaming country in which the mobile terminal 100 is currently located. The country list may be stored in the memory 120 in advance.

The controller 130 determines in step S150 whether the user has selected a current roaming country from the country list.

If it is determined in step S150 that a roaming country has been selected from the country list, the controller 130 determines in step S160 whether a power source frequency of the selected roaming country is equal to the power source frequency of the mobile terminal 100. In this case, the controller 130 can check the power source frequency of the selected roaming country from the memory 120 storing a power source frequency of each country and a camera register value for adjusting a camera clock frequency according to the power source frequency. For example, if the user has selected “Great Britain” as the roaming country, the controller 130 can check from Table 1 that the power source frequency of “Great Britain” is 50 Hz. Thus, the controller 130 can determine whether the two power source frequencies are the same, by comparing the checked power source frequency and the power source frequency of the mobile terminal 100.

If it is determined in step S160 that the power source frequency of the selected roaming country is not equal to the power source frequency of the mobile terminal 100, the controller 130 reads a camera register value corresponding to the power source frequency of the selected roaming country from the memory 120 and sets the camera register value in the camera register in step S170.

The controller 130 adjusts the camera clock frequency using the set camera register value in step 180. That is, the controller 130 generates a camera clock frequency according to the newly set camera register value and outputs the camera clock frequency to the camera module 160.

If it is determined in step S160 that the power source frequency of the selected roaming country is equal to the power source frequency of the mobile terminal 100, since the camera register value does not have to be changed, the controller 130 directly performs the roaming service without performing the camera clock frequency adjusting process.

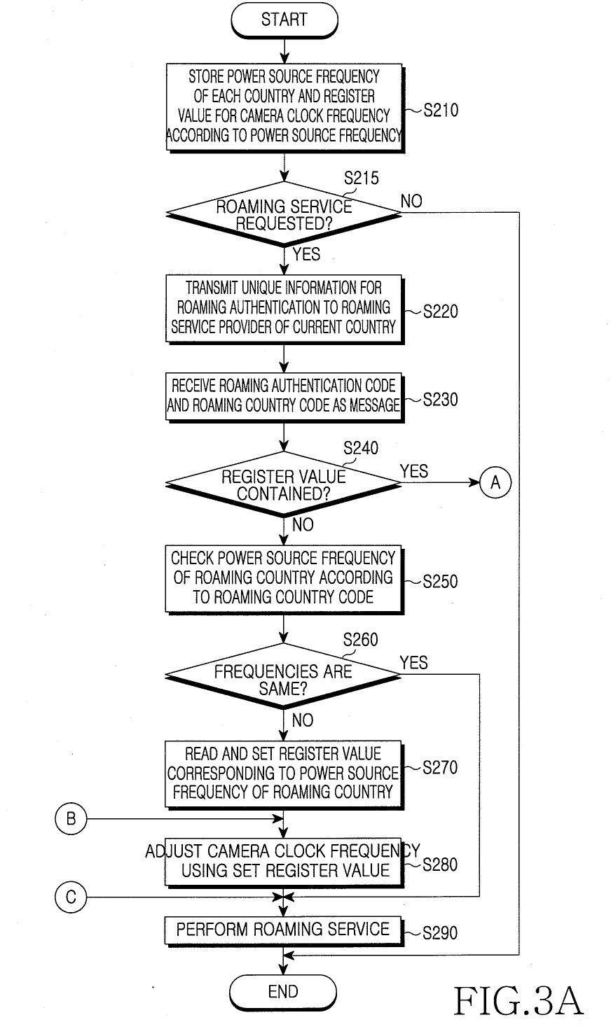

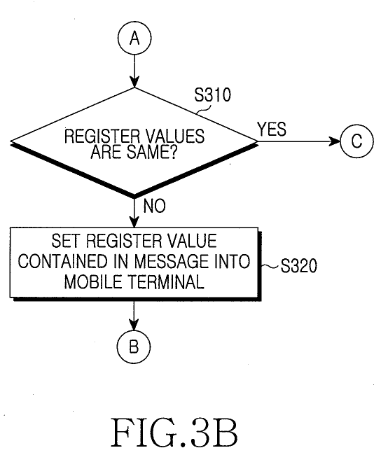

FIGS. 3A and 3B are flowcharts of a camera roaming service method of a mobile terminal according to another exemplary embodiment of the present invention.

Referring to FIGS. 1, 3A, and 3B, the controller 130 stores a power source frequency of each country and a camera register value for adjusting a camera clock frequency according to the power source frequency in the memory 120 in step S210.

The controller 130 determines in step S215 whether the user has requested a roaming service. The user can request the roaming service by means of a menu or a pre-set key input.

If it is determined in step S215 that the user has requested the roaming service, the controller 130 controls the RF transceiver 140 to transmit unique information (e.g., the ESN) of the mobile terminal 100 for roaming authentication to a roaming service provider of a country in which the mobile terminal 100 is currently located in step S220.

The controller 130 receives a roaming authentication code and a roaming country code from the roaming service provider via the RF transceiver 140 in step S230. The roaming service provider may transmit the roaming authentication code and the roaming country code as a message.

The controller 130 determines in step S240 whether the message contains a camera register value for adjusting the camera clock frequency. The camera register value may be contained in a country code and received.

If it is determined in step S240 that the message does not contain the camera register value, the controller 130 checks a power source frequency of a roaming country corresponding to the roaming country code in step S250. That is, after the controller 130 detects the roaming country from the country code, the controller 130 can detect a power source frequency of the roaming country from Table 1 stored in the memory 120, and if the country code is contained in Table 1, the controller 130 can detect the power source frequency of the roaming country without separately detecting the roaming country code.

The controller 130 determines in step S260 whether the power source frequency of the roaming country is equal to the power source frequency of the mobile terminal 100.

If it is determined in step S260 that the power source frequency of the roaming country is not equal to the power source frequency of the mobile terminal 100, the controller 130 reads a camera register value corresponding to the power source frequency of the roaming country from the memory 120 and sets the read camera register value in the camera register in step S270. That is, the controller 130 updates a value of the camera register to the read camera register value.

The controller 130 adjusts the camera clock frequency using the set camera register value in step S280. That is, the controller 130 generates a camera clock frequency according to the newly set camera register value and outputs the camera clock frequency to the camera module 160.

After adjusting the camera clock frequency, the controller 130 performs the roaming service in step 290.

If it is determined in step S260 that the power source frequency of the roaming country is equal to the power source frequency of the mobile terminal 100, since the value of the camera register does not have to be changed, the controller 130 performs the roaming service in step 290 without adjusting the camera clock frequency.

If it is determined in step S240 that the message contains the camera register value, the controller 130 determines in step S310 whether the camera register value contained in the message is equal to a current camera register value of the mobile terminal 100.

If it is determined in step S310 that the camera register value contained in the message is not equal to the current camera register value of the mobile terminal 100, the controller 130 sets the camera register value contained in the message in the camera register of the mobile terminal 100 in step S320.

Thereafter, the controller 130 proceeds to step S280.

If it is determined in step S310 that the camera register value contained in the message is equal to the current camera register value of the mobile terminal 100, the controller 130 proceeds to step S290 to perform the roaming service without adjusting the camera clock frequency.

As described above, according to the exemplary embodiments of the present invention, when an international roaming service is performed, a camera clock frequency can be adjusted according to a power source frequency of a roaming country. In addition, since optimal image quality of a camera can be obtained everywhere a roaming service is performed (in particular, indoors), a user can capture a clear image.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A camera roaming service method of a mobile terminal, the method comprising:
if camera roaming of a roaming country in which the mobile terminal is currently located is requested, determining whether a power source frequency of the roaming country is equal to a power source frequency of the mobile terminal; and
if the two power source frequencies are not the same, adjusting a camera clock frequency according to the power source frequency of the roaming country.

2. The method of claim 1, wherein the camera roaming is requested by a user during a roaming service.

3. The method of claim 1, further comprising storing a power source frequency for at least one country and a camera register value for adjusting a camera clock frequency according to the power source frequency.

4. The method of claim 3, wherein the determining comprises:
if the camera roaming is requested by a user, displaying a list for allowing the user to select a roaming country; and
determining whether a power source frequency of the roaming country is equal to the power source frequency of the mobile terminal based on the user's selection.

5. The method of claim 3, wherein the adjusting comprises:
if the two power source frequencies are not the same, reading a camera register value corresponding to the power source frequency of the roaming country; and
adjusting the camera clock frequency using the read camera register value.

6. A camera roaming service method of a mobile terminal, the method comprising:
receiving a roaming authentication code and a roaming country code as a message from a roaming service provider of a country in which the mobile terminal is currently located during a roaming service;
determining whether a power source frequency of a roaming country corresponding to the received roaming country code is equal to a power source frequency of the mobile terminal; and
if the two power source frequencies are not the same, adjusting a camera clock frequency according to the power source frequency of the roaming country.

7. The method of claim 6, further comprising storing a power source frequency for at least one country and a camera register value for adjusting a camera clock frequency according to the power source frequency.

8. The method of claim 7, wherein the adjusting comprises:
if the two power source frequencies are not the same, reading a camera register value corresponding to the power source frequency of the roaming country; and
adjusting the camera clock frequency using the read camera register value.

9. The method of claim 6, further comprising:
determining whether the message contains a camera register value for adjusting the camera clock frequency according to the power source frequency of the roaming country;
if it is determined that the message contains a camera register value, determining whether the camera register value contained in the message is equal to a currently set camera register value of the mobile terminal; and
if it is determined that the two camera register values are not the same, adjusting the camera clock frequency by setting the camera register value of the mobile terminal to the camera register value contained in the message.

10. A mobile terminal equipped with a camera, the mobile terminal comprising:
a memory for storing a power source frequency for at least one country and a camera register value for adjusting a clock frequency of the camera according to the power source frequency; and
a controller for adjusting the camera clock frequency by reading a camera register value, which corresponds to a power source frequency of a roaming country in which the mobile terminal is currently located, from the memory if camera roaming of the roaming country is requested during a roaming service.

11. The mobile terminal of claim 10, wherein if the power source frequency of the roaming country is not equal to a power source frequency of the mobile terminal, the controller adjusts the camera clock frequency according to the power source frequency of the roaming country.

12. The mobile terminal of claim 10, wherein if the power source frequency of the roaming country is not equal to the power source frequency of the mobile terminal, the controller reads a camera register value corresponding to the power source frequency of the roaming country from the memory and adjusts the camera clock frequency using the read camera register value.

13. A mobile terminal having a camera, the mobile terminal comprising:
a memory for storing at least one power source frequency of a country and a camera register value for adjusting a clock frequency of the camera according to the power source frequency;
a Radio Frequency (RF) transceiver for transmitting unique information of the mobile terminal for roaming authentication in a roaming service to a roaming service provider of a country in which the mobile terminal is currently located and receiving a roaming authentication code and a roaming country code as a message from the roaming service provider; and
a controller for adjusting the camera clock frequency by reading a camera register value, which corresponds to a power source frequency of a roaming country corresponding to the received roaming country code, from the memory.

14. The mobile terminal of claim 13, wherein if the power source frequency of the roaming country is not equal to a power source frequency of the mobile terminal, the controller adjusts the camera clock frequency according to the power source frequency of the roaming country.

15. The mobile terminal of claim 14, wherein if the power source frequency of the roaming country is not equal to the power source frequency of the mobile terminal, the controller reads a camera register value corresponding to the power source frequency of the roaming country from the memory and adjusts the camera clock frequency using the read camera register value.

16. The mobile terminal of claim 13, wherein if the message contains a camera register value for adjusting the camera clock frequency, the controller compares the camera register value contained in the message and a currently set camera register value of the mobile terminal, and adjusts the camera clock frequency by setting the camera register value of the mobile terminal to the camera register value contained in the message if the two camera register values are not the same.
